(19) United States
(12) Patent Application Publication
(10) Pub. No.: US 2021/0073410 A1
(43) Pub. Date: Mar. 11, 2021

(54) SECURE DATASET MANAGEMENT

(71) Applicant: Microsoft Technology Licensing, LLC, Redmond, WA (US)

(72) Inventors: Ying YAN, Redmond, WA (US); Zhongxin GUO, Redmond, WA (US); Lidong ZHOU, Redmond, WA (US); Atsushi KOSHIBA, Redmond, WA (US)

(21) Appl. No.: 17/044,278

(22) PCT Filed: Apr. 29, 2019
(86) PCT No.: PCT/US2019/029555

§ 371 Date: Sep. 30, 2020

(30) Foreign Application Priority Data
May 15, 2018 (CN) 201810462520.2

(51) Int. Cl. G06F 21/62; G06F 21/53; G06F 16/22; G06F 21/78

(52) U.S. Cl. CPC G06F 21/6227; G06F 21/78; G06F 16/2272; G06F 21/53

(57) ABSTRACT

According to implementations of the subject matter described herein, a solution for security management of a dataset is proposed. In this solution, a dataset comprising at least one record is obtained, a record of the at least one record at least comprising: a keyword for identifying the record; and a value corresponding to the keyword. Subsequently, a keyword index is created in a trusted execution environment on the basis of respective keywords of the at least one record. Here the keyword index describes a set of keywords of the at least one record. By means of the solution, the keyword index may be created for records in the dataset in the trusted execution environment, and based on the keyword index, the dataset may be managed in a more secure and reliable way so as to detect a possible anomaly in the dataset.

### BACKGROUND

With the development of data storage technologies and data security technologies, data storage solutions based on encryption-decryption technologies have been developed so as to improve the security of data storage. However, stored data are often confronted with threats from malware such as viruses or other many risks, therefore it is desirable to develop more secure and reliable data storage environments. In particular, for financial institutions or organizations such as government organs, they need to further improve the security of data management. So far, data security technologies having higher security levels have been proposed. For example, hardware and/or software-based trusted execution environments (abbreviated as TEEs) may effectively isolate threats from the outside and provide secure and protected execution environments for applications.

Nevertheless, on one hand, TEEs are typically expensive, and computing resources and storage resources provided by TEEs are rather limited. On the other hand, when an existing data storage-based application wants to be ported to a TEE, both the existing application and data storage need to be modified so as to adapt to the TEE, whereas modifying the existing application and data storage certainly produces extra overhead. Therefore, it is desirable to provide a technical solution for improving the security of an application, especially a data storage-based application in a more convenient and reliable way.

### SUMMARY

In accordance with implementations of the subject matter described herein, a solution for security management of a dataset is provided. In this solution, a dataset comprising at least one record is obtained, a record of the at least one record at least comprising: a keyword for identifying the record; and a value corresponding to the keyword; a keyword index is created in a trusted execution environment on the basis of respective keywords of the at least one record, the keyword index describing a set of keywords of the at least one record.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a block diagram of a computing environment in which multiple implementations of the subject matter described herein can be implemented;

FIG. 2 illustrates a general block diagram of a solution for security management of a dataset according to one implementation of the subject matter described herein;

FIG. 3 illustrates a flowchart of a method for security management of a dataset according to one implementation of the subject matter described herein;

FIG. 4 illustrates a flowchart of a method for adding a new record to a dataset according to one implementation of the subject matter described herein;

FIG. 5 illustrates a detailed block diagram for security management of a dataset according to one implementation of the subject matter described herein;

FIGS. 6A and 6B each illustrate a block diagram for detecting an anomaly in a dataset according to the implementations of the subject matter described herein;

FIG. 7 illustrates a block diagram for managing a blockchain based database according to one implementation of the subject matter described herein; and

FIG. 8 illustrates a block diagram for managing a relational database according to one implementation of the subject matter described herein.

Throughout the drawings, the same or similar reference symbols refer to the same or similar elements.

### DETAILED DESCRIPTION

The subject matter described herein will now be discussed with reference to several example implementations. It is to be understood these implementations are discussed only for the purpose of enabling those skilled persons in the art to better understand and thus implement the subject matter described herein, rather than suggesting any limitations on the scope of the subject matter.

As used herein, the term “comprises” and its variants are to be read as open terms that mean “comprises, but is not limited to.” The term “based on” is to be read as “based at least in part on.” The term “one implementation” and “an implementation” are to be read as “at least one implementation.” The term “another implementation” is to be read as “at least one other implementation.” The terms “first,” “second,” and the like may refer to different or same objects. Other definitions, explicit and implicit, may be included below.

Several companies have developed their respective TEEs. For example, Intel® Corporation has developed the technology called Software Guard Extensions (abbreviated as SGX). SGX can protect an application and corresponding data storage (e.g. database) from being disclosed or modified, which is made possible by enclave technology, i.e. deploying the application and the database in a protected execution region in memory. Based on the SGX technology, applications desiring to obtain higher security assurance may be put into an enclave. Applications running inside the enclave may be prevented from attack of malware, and even an operating system and/or hypervisor cannot affect applications and databases inside the enclave. In this way, hardware-based trusted execution environments may be provided.

Further, software-based TEE technical solutions have been proposed. For example, Windows Virtual Secure Mode (abbreviated as VSM) developed by Microsoft® Corporation is one example of software-based TEEs. Based on the VSM technology, higher security guarantee may be provided to applications and data without a need to purchase extra professional software.

It will be understood although SGX and VSM are shown as specific examples of TEEs throughout the context of the subject matter described herein, those skilled in the art may appreciate more TEEs may be developed with technological progress. Moreover, TEEs described in the subject matter described herein may be other execution environments that have been developed or will be developed in future.

So far, technical solutions for implanting existing applications and databases into TEEs have been developed. In one technical solution, a database and all applications for accessing the database may be implanted into a TEE. However, this costs huge manpower and time overhead and imposes strict requirements on various resources (e.g. computing resources and storage resources) of the TEE. Therefore, this technical solution can hardly be put into extensive use, especially applied to applications involving a large data amount.

In another technical solution, an application and an interface portion in the application which is associated with an accessed database may be implanted into a TEE. Admittedly, this technical solution can reduce various overhead involved in the implanting to some extent, whereas the technical solution needs a large number of technical persons to rewrite code of the database interface portion and imposes high requirements on skill levels of the technical persons.

Therefore, it is desirable to provide a technical solution for improving the security of applications and data storage in a convenient and effective way. Further, it is desired that the technical solution can be compatible with existing data storage systems and effect more secure data storage without changing hardware configuration of existing data storage systems as far as possible.

### Example Environment

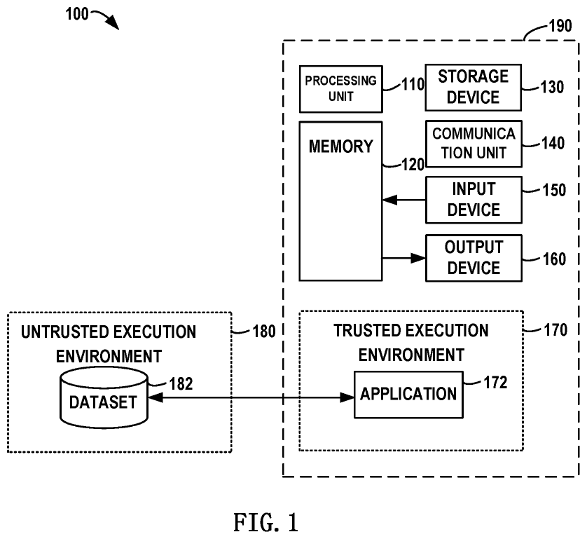

Basic principles and various example implementations of the subject matter described herein will now be described with reference to the drawings. FIG. 1 illustrates a block diagram of a computing environment 100 in which implementations of the subject matter described herein can be implemented. As illustrated in FIG. 1, the computing environment 100 may comprise execution environments having different security levels. For example, based on the above described SGX or VSM, a computing device 190 may comprise a TEE 170 having a higher security level and run an application 172 in the TEE 170. Further, the computing device 190 may communicate with an external untrusted execution environment 180 having a lower security level. For example, the application 172 in the TEE 170 may access a dataset 182 in the untrusted execution environment 180.

In this example environment, the TEE 170 may be an SGX technical solution developed by Intel® Corporation or a VSM technical solution developed by Microsoft® Corporation. The untrusted execution environment 180 here may be a conventional computing environment, in other words, a conventional computing environment that does not utilize SGX technology or VSM technology. It will be understood although only SGX and VSM technologies are used as specific examples of the TEE 170 in the subject matter described herein, with more data security technologies to emerge, the TEE 170 here may be any TEE that is currently known or to be developed in future.

It will be understood that the computing device 190 described in FIG. 1 is merely for illustration and not limit the function and scope of implementations of the subject matter described herein in any manners. As shown in FIG. 1, the computing device 190 includes a computing device 190 in form of a general computer device. Components of the computing device 190 include, but are not limited to, one or more processors or processing units 110, a memory 120, a storage device 130, one or more communication units 140, one or more input devices 150, and one or more output devices 160.

In some implementations, the computing device 190 may be implemented as various user terminals or service terminals. The service terminals may be large-scale computing device and servers provided by various service providers, etc. The user terminals may be, for example, any type of mobile terminals, stationary terminals or portable terminals, including mobile phones, stations, cells, devices, multimedia computers, multimedia tablets, Internet nodes, communicators, desktop computers, laptop computers, notebook computers, netbook computers, tablet computers, personal communication system (PCS) devices, personal navigation devices, personal digital assistants (PDA), audio/video players, digital cameras/video cameras, positioning devices, TV receives, radio broadcast receivers, ebook devices, game devices or any combinations thereof, including accessories and peripherals of these devices or any combinations of. It may be further anticipated the computing device 100 can support any type of interfaces (such as “wearable” circuits, etc.) to users.

The processing unit 110 can be a physical or virtual processor and can execute various processes based on the programs stored in the memory 120. In a multi-processor system, multiple processing units execute computer-executable instructions in parallel to improve the parallel processing capacity of the computing device 190. The processing unit 110 may also be referred to as a central processing unit (CPU), microprocessor, controller, or microcontroller.

The computing device 190 typically includes a plurality of computer storage media, which can be any available media accessible by the computing device 100, including but not limited to volatile and non-volatile media, and removable and non-removable media. The memory 120 can be a volatile memory (for example, a register, cache, Random Access Memory (RAM)), non-volatile memory (for example, a Read-Only Memory (ROM), Electrically Erasable Programmable Read-Only Memory (EEPROM), flash memory), or any combination thereof. The memory 120 includes one or more program products so as to implement a database management system 122 for managing a co-ownership database system. The management engine has one or more sets of program modules configured to perform functions of various implementations described herein. The storage device 130 can be any removable or non-removable media and may include machine-readable media, such as a memory, flash drive, disk, and any other media, which can be used for storing information and/or data and accessed in the computing device 190.

The computing device 190 may further include additional removable/non-removable, volatile/non-volatile memory media. Although not shown in FIG. 1, a disk drive is provided for reading and writing a removable and non-volatile disk and a disc drive is provided for reading and writing a removable non-volatile disc. In such case, each drive is connected to the bus (not shown) via one or more data media interfaces.

The communication unit 140 communicates with a further computing device via communication media. Additionally, functions of components in the computing device 100 can be implemented by a single computing cluster or multiple computing machines connected communicatively for communication. Therefore, the computing device 190 can be operated in a networking environment using a logical link with one or more other servers, network personal computers (PCs) or another general network node.

The input device 150 may include one or more input devices, such as a mouse, keyboard, tracking ball, voice-input device, and the like. The output device 160 may include one or more output devices, such as a display, loudspeaker, printer, and the like. As required, the computing device 190 can also communicate via the communication unit 140 with one or more external devices (not shown) such as a storage device, display device and the like, one or more devices that enable users to interact with the computing device 190, or any devices that enable the computing device 190 to communicate with one or more other computing devices (for example, a network card, modem, and the like). Such communication is performed via an input/output (I/O) interface (not shown).

A method for security management of a dataset may be implemented in the computing device 190 as shown in FIG. 1. With the method of the subject matter described herein, it may be guaranteed that the application 172 in the TEE 170 may access the dataset 182 in the untrusted execution environment 180 in a more secure and reliable way. In general, a communication interface may be built between the TEE 170 and the untrusted execution environment 180 so as to improve the security of the dataset 182.

### Working Principles

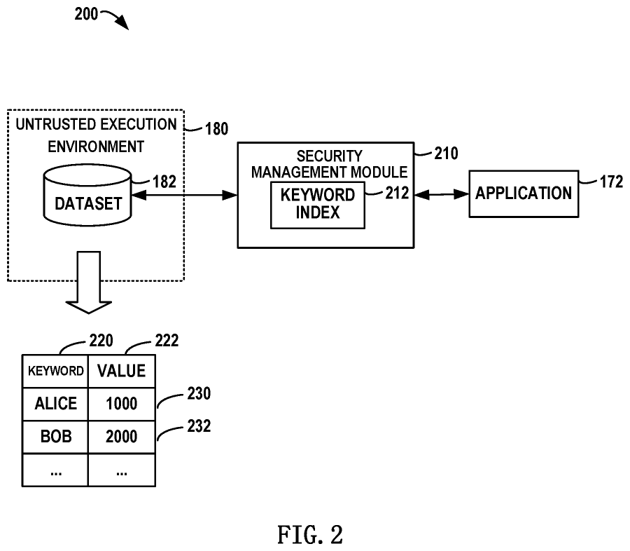

Working principles of the solution of the subject matter described herein will be described in detail with reference to the accompanying drawings. According to implementations of the subject matter described herein, there is provided a solution for security management of a dataset. First with reference to FIG. 2, a summary is presented to the solution. FIG. 2 schematically shows a general block diagram 200 for security management of a dataset according to one implementation of the subject matter described herein. As depicted, a security management module 210 may be provided between the application 172 in the TEE 170 and the dataset 182 in the untrusted execution environment 180, as an interface between the application 172 and the dataset 182. The security management module 210 receives a request from the application 172 and accesses the dataset 182 on the basis of the request. Subsequently, the security management module 210 returns to the application 172 a result from the dataset 182.

In this implementation, the dataset 182 may comprise multiple records 230, 232, etc., and each record may comprise a keyword 220 for identifying the record and a value 222 corresponding to the keyword 220. For example, data about bank accounts may be stored in the dataset 182, at which point the keyword 220 may represent an account name for example and the value 222 may denote an account balance for example. It will be understood although FIG. 2 illustrates the dataset 182 comprising only two fields: keyword and value, in other implementations the dataset 182 may further comprise more fields. For example, the dataset 182 may further comprise other account attributes, such as gender, occupation, etc.

It will be understood that the dataset 182 is deployed in the untrusted execution environment 180 and is vulnerable to attack of malware such as viruses. Malware might add a new record to the dataset 182, for example, insert a record of an account that does not exist. Or, malware might further delete a record of a normal account from the dataset 182. At this point, even if the application 172 runs in the secure and reliable TEE 170, since the data security in the dataset 182 in the untrusted execution environment 180 has been destroyed, the application 172 will get a wrong result.

As shown in FIG. 2, to improve the security of the dataset 182, the implementations of the subject matter described herein provide the security management module 210 and a keyword index 212. Specifically, the dataset 182 comprising at least one record may be obtained. Then, the keyword index 212 is created in the TEE 170 on the basis of respective keyword(s) 220 of at least one record in the dataset 182. Here, the keyword index 212 may describe a set of keywords of the at least one record, and the dataset 182 may be managed at a higher security level.

In the implementations of the subject matter described herein, the keyword index 212 records a set of keywords in the dataset 182 as obtained in a normal state. Even if an anomaly occurs in the dataset 182 later (e.g. new account information is added by malware), by comparing keywords in the dataset 182 with the keyword index 212 created on the basis of a correct dataset, it may be determined whether the dataset 182 has an anomaly. In this way, the security of the dataset 182 may be improved, and further the reliability of the application 172 in the TEE 170 may be guaranteed.

### Example Process

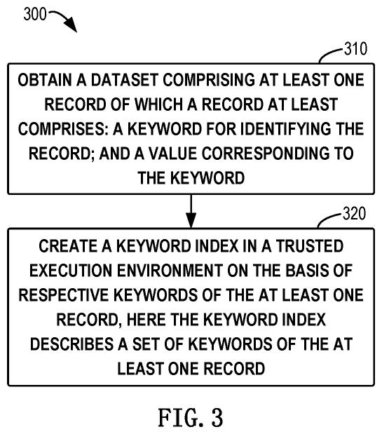

With reference to FIG. 3, a detailed description is presented below to the detailed operation flow of the method of the subject matter described herein. FIG. 3 illustrates a flowchart 300 of a method for security management of a dataset according to one implementation of the subject matter described herein. As depicted in FIG. 3, a dataset 182 comprising at least one record may be obtained 310. In this implementation, each record of the at least one record comprises at least: a keyword 200 for identifying the record, and a value 222 corresponding to the keyword. It will be understood that the dataset 182 may be obtained in different ways. For example, since the application 172 runs in the TEE 170, it may be considered that data from the application 172 is authentic data. Thereby, the dataset 182 may be obtained when the application 172 adds a record to the dataset 182. For another example, a record in the dataset 182 may further be obtained at any time point when the dataset 182 is confirmed as normal. At this point, since records in the dataset 182 are correct and have not been attacked by malware, a keyword index 212 created on the basis of obtained records in the dataset 182 will be secure and trusted and may act as a basis for subsequent management of the dataset 182.

Next, the keyword index 212 may be created 320 in the TEE 170 on the basis of respective keyword(s) 220 of the at least one record, so as to manage the dataset 182. Here, the keyword index 212 describes a set of keywords of the at least one record. It will be understood that the keyword index 212 may be created in various ways. For example, in a simplified implemented, a list may be built, and keywords of all records in the dataset 182 are added to the list to form the keyword index 212. For another example, a set may further be built, and keywords of all records in the dataset 182 are added to the set to form the keyword index 212.

It will be understood when the dataset 182 contains a large number of records, creating the keyword index 212 by means of the list or set described above will occupy large amount of storage spaces and might lead to low retrieval efficiency when managing the dataset 182 later. Therefore, the keyword index 212 may further be created on the basis of a hash function. Specifically, each keyword 220 in the dataset 182 may be mapped to one bit in a bit map by a hash function. When there is a need to determine whether the keyword index 212 contains a specific keyword, a value of a bit corresponding to the specific keyword may be looked up in the bitmap. Based on the principle, those skilled in the art may use different hash functions to create the keyword index 212. Specifically, since a Bloom filter is highly advantageous in terms of storage spaces and search time, the keyword index 212 may be implemented on the basis of a Bloom filter.

It will be understood while the application 172 is running, the application 172 might add a new record to the dataset 182. For example, in the foregoing example of a bank account database, when a user opens a new account in a bank, a new account record may be added to the dataset 182. In this case, besides updating records in the dataset 182, contents of the keyword index 212 need to be updated.

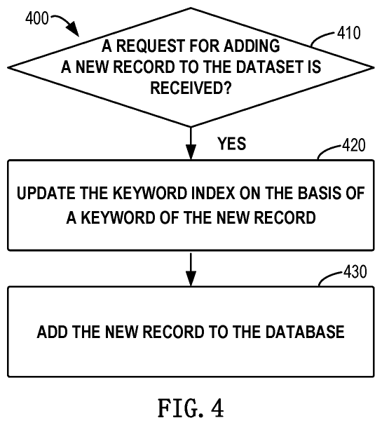

Specifically, FIG. 4 schematically illustrates a flowchart 400 of a method for adding a new record to the dataset 182 according to one implementation of the subject matter described herein. As depicted, if a request for adding a new record to the dataset 182 is received 410, the keyword index 212 may be updated 420 on the basis of a newly recorded keyword, and the new record may be added to the dataset 182. It will be understood although the operations of updating the keyword index 212 and adding the new record to the dataset 182 are shown in a serial way in FIG. 4, in other implementations these operations may be executed in parallel or in reverse order.

It will be understood while the application 172 is running, the application 172 might delete an existing record from the dataset 182. For example, in the foregoing example of a bank account database, when the user closes a bank account, an existing account record may be deleted from the dataset 182. At this point, in addition to updating records in the dataset 182, contents of the keyword index 212 need to be updated.

It will be understood although the subject matter described herein describes a case where a new record is added to the dataset 182 and an existing record is deleted from the dataset 182, in some cases only a new record is allowed to be added to the dataset 182, while an existing record is not allowed to be deleted therefrom. For example, suppose the application 172 is an application monitoring the running state of the computing device 190, as the computing device 190 is running, the application 172 will insert new log data to the dataset 182 at predefined time intervals. At this point, existing logs are not allowed to be deleted from the dataset 182.

### Implementation Examples in Trusted Execution Environment

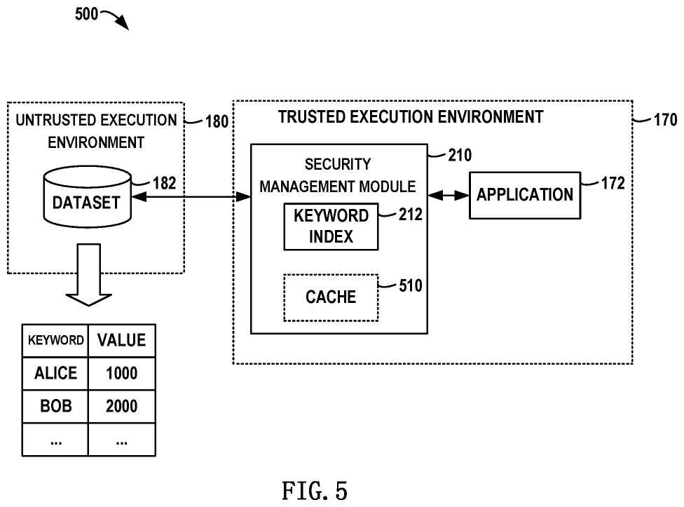

According to one example implementation of the subject matter described herein, to manage the dataset 182 in a more secure and reliable way, the keyword index 212 may be created in the TEE 170. With reference to FIG. 5, a detailed description is presented below to more specific implementations in the TEE 170. FIG. 5 schematically shows a detailed block diagram 500 for security management of the dataset 182 according to one implementation of the subject matter described herein. As depicted, the security management module 210 according to the subject matter described herein may be deployed in the TEE 170.

It will be understood since the TEE 170 provides a much higher security level than the untrusted execution environment 180, the keyword index 212 may be created and stored in the TEE 170 so as to ensure the keyword index 212 itself is secure and protected from attach of malware such as viruses. At this point, the keyword index 212 is trusted and can be act as a basis for a subsequent comparison with various keywords in the dataset 182. In this way, the security of the dataset 182 may be further improved.

In one example implementation of the subject matter described herein, the security management module 210 may further comprise a cache 510. At this point, if an access request for accessing the dataset 182 is received, a record associated with the access request may be added to the cache 510 (as shown in a dashed box in FIG. 5) in the TEE 170. It will be understood that the number of various resources contained in the TEE 170 is limited. In some implementations, the size of the cache 510 may be set depending on factors such as the specific configuration of the TEE 170 and the requirement of the application 172 on data access efficiency. The cache 510 may be updated according to the least recently used policy, for example. In this implementation, the cache 510 resides in the TEE 170, so that on the one hand higher security may be provided, and on the other hand, faster response speed may be provided to the application 172.

In one example implementation of the subject matter described herein, the method according to the subject matter described herein may be executed in the TEE 170. For example, the security management module 210 (e.g. implemented as a computer program) as shown in FIG. 5 may be deployed, and the security management module 210 may be loaded to the TEE 170. In this implementation, the cache 510, the keyword index 212 and the security management module 210 for performing security management to the dataset 182 are all deployed in the TEE 170. In this way, it may be ensured that each factor involved in security management is secure. Therefore, it may be considered that all operations performed in the TEE 170 as shown in FIG. 5 are secure.

### Detect State of Dataset

In one example implementation of the subject matter described herein, whether the dataset 182 contains an anomaly may be determined depending on whether a keyword in the dataset 182 matches a keyword in the keyword index 212. In the example of the above described dataset 182 storing back account information, suppose the dataset 182 in the untrusted execution environment 180 is attacked, and a new account record is added to the dataset 182. At this point, by comparing a keyword in the dataset 182 with the keyword index 212, it can be found that the new account record does not exist in the keyword index 212, and further it may be determined whether the dataset 182 contains an anomaly.

It will be understood when the keyword index 212 is implemented in different ways, the approach to judging “a match”/“mismatch” may differ. For example, when the keyword index 212 is implemented using the above described list/set, if the list/set comprises a specific keyword, then it is considered that the specific keyword matches the keyword index 212; otherwise, a mismatch is concluded. For another example, when the keyword index 212 is implemented using the above described hash function, a “match”/“mismatch” result may be obtained by checking a value of a bit in the keyword index 212 which corresponds to the specific keyword. In one example, if the value of the bit corresponding to the specific keyword is “1” (or other predefined value), then the judgment result is “match,” otherwise the judgment result is “mismatch.”

In one example implementation of the subject matter described herein, the comparison operation may be executed periodically. Alternatively, the comparison operation may further be executed when an access request to the dataset 182 is received. Specifically, whether an anomaly occurs in the dataset 182 may be determined depending on a judgment result of “match”/“mismatch.”

In one example implementation of the subject matter described herein, a target keyword associated with a received request may be received on the basis of the request. Here, the target keyword refers to a keyword of a record to be accessed as the request defines. For example, regarding a request desiring to access a record on ALICE, the target keyword is “ALICE.” For example, suppose the keyword index 212 comprises ALICE and BOB. If a request for reading a record whose keyword is ALICE is received, first it may be looked up in the dataset 182 whether there exists a record whose keyword is ALICE. If yes, then the found record is returned to the TEE 170 in an encrypted fashion. If the decryption succeeds in the TEE 170, then it is determined the record whose keyword is ALICE is a record that used to exist in the dataset 182, other than a record that is added by malware. At this point, it may be determined that the dataset 182 is in normal state, and the found target record is returned. Alternatively, if the record whose keyword is ALICE is found in the dataset 182, first it may be determined whether the keyword ALICE exists in the keyword index 212; if yes, then this means the dataset 182 is normal and subsequent decryption may be performed. In this way, it may be judged in advance whether the encrypted record is trusted, and subsequent decryption is performed only when the encrypted record is trusted.

In one example implementation of the subject matter described herein, suppose the keyword index 212 comprises ALICE and BOB. If a request for reading a record whose keyword is TOM is received, then it may be looked up in the dataset 182 whether there exists a target record comprising the keyword TOM. If the target record comprising the keyword TOM is not found in the dataset 182, then it may be further determined whether the keyword TOM exists in the keyword index 212. If not, then an indication may be returned to indicate the dataset 182 does not comprise a record whose keyword is TOM. At this point, the dataset 182 is in normal state.

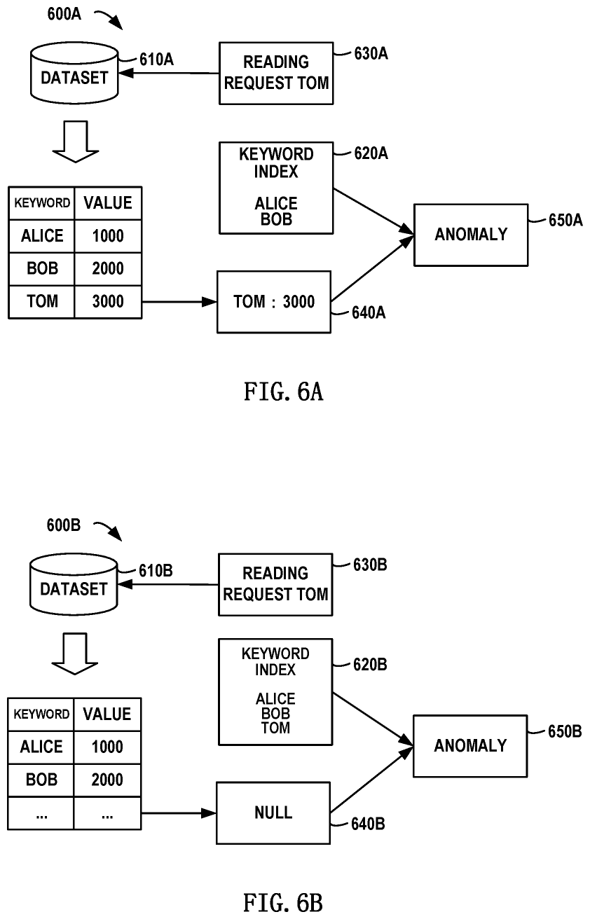

Cases where the dataset 182 is in normal state have been introduced above. With reference to FIGS. 6A and 6B, a detailed description is presented below to how to detect an anomaly in the dataset 182. FIG. 6A schematically shows a block diagram 600A for detecting an anomaly in the dataset 182 according to one implementation of the subject matter described herein. In FIG. 6A, a keyword index 620A created by the implementation of the subject matter described herein is illustrated, at which point the keyword index 620A comprises 2 keywords, i.e. ALICE and BOB. Note since the keyword index 620A is created and stored in the TEE 170, the keyword index 620A may be considered secure and reliable.

Suppose a dataset 610A in the untrusted execution environment 180 has been attacked, and a record on a new account TOM has been added. At this point, when a reading request 630A for reading from the dataset 610A information on the account TOM is received, an encrypted record 640A (the record reads that the account TOM has a balance of 3000 yuan) may be returned from the dataset 610A. If decryption in the TEE 170 fails, then this means the keyword TOM does not exist in the keyword index 620A. Therefore, the record on the account TOM in the dataset 610A is added by malware, and further it may be determined that the dataset 610A contains an anomaly. Alternatively, decryption may not be performed, but first it is determined whether the keyword TOM exists in the keyword index 620A; if not, then it may be directly determined that the dataset 610A is abnormal. In this way, besides the existing encryption-decryption based data security management, an additional data security management solution may further be provided.

FIG. 6B schematically shows a block diagram 600B for detecting an anomaly in the dataset 182 according to one implementation of the subject matter described herein. In FIG. 6B, a keyword index 620B created by the implementation of the subject matter described herein is illustrated, at which point the keyword index 620B comprises 3 keywords, i.e. ALICE, BOB and TOM. Note since the keyword index 620B is created and stored in the TEE 170, the keyword index 620B may be considered secure and reliable.

Suppose a dataset 610B in the untrusted execution environment 180 has been attacked, and a record on a new account TOM has been deleted. At this point, when a reading request 630B for reading from the dataset 610B information on the account TOM is received, a query result is null. At this point, since the keyword index 620B comprises the keyword TOM, but the query result is null, it may be determined that the record on the account TOM in the dataset 610B has been deleted by malware and the dataset 610B contains an anomaly.

In the foregoing implementations, whether the dataset 182 contains an anomaly may be determined simply by comparing a keyword in the dataset 182 with the keyword index 212 to see whether they match with each other. In this way, the state of the dataset 182 may be detected in an easier and more effective way without a large computation amount.

Although cases where malware adds a new record to the dataset 182 and deletes an existing record from the dataset 182 have been described above, when the dataset is for storing log records, it may be only detected whether a new record is added to the dataset 182.

### Examples of Dataset

The specific process for security management of the dataset 182 has been described by taking as an example the simple dataset 182 comprising an account name and an account balance. Hereinafter, more specific examples of the dataset 182 will be described. Note throughout the context of the subject matter described herein, it is not intended to limit the number of fields comprised by each record in the dataset 182. In other implementations, the dataset may comprise more fields. For example, the dataset 182 for storing bank account data may further comprise other attributes, such as gender, occupation, etc.

In one example implementation of the subject matter described herein, the dataset 182 may be a dataset of a blockchain based database, and a record of at least one record in the dataset 182 describes a keyword and a value of a node in the blockchain. It will be understood that the blockchain is a linked data structure in which data blocks are sequentially connected in time order, and the data structure of the blockchain is provided with properties of traceable and verifiable integrity. Data at various nodes in the blockchain cannot be modified, but a newly added node may be appended to the end of the blockchain. Since the blockchain technology can effectively prevent data from being tampered and can record an operation history of stored data in a more reliable way, the blockchain technology has been widely used.

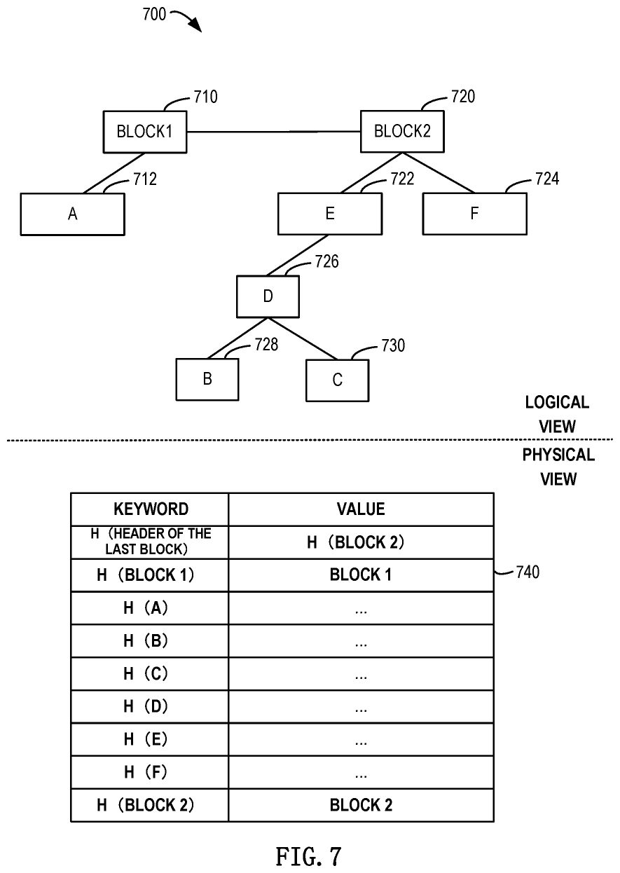

With reference to FIG. 7, a detailed description is presented below to more details of applying the method of the subject matter described herein in a blockchain based database. FIG. 7 schematically shows a block diagram 700 for managing a dataset of a blockchain based database according to one implementation of the subject matter described herein. The upper portion of FIG. 7 illustrates a logical view of the blockchain based database. In this logical view, a block 1 (denoted as a node 710) and a block 2 (denoted as a node 720) are linked together, and the node 720 behind records an event happening at a time point later than that of the node 710.

The blockchain may be created based on a Merkle tree. It will be understood that Merkle is a tree structure, which may be binary tree or a multi-way tree. A leaf node of the Merkle tree may have a value (including data related to contents to be saved), and a value of a non-leaf node is calculated from values of all lower leaf nodes. For example, in a Merkle hash tree, a leaf node may store data to be saved (e.g. the above described account information comprising an account name and an account balance), and a non-leaf node stores a hash value of child-node contents of the non-leaf node.

In the Merkle tree as shown in FIG. 7, the node 710 may record account information at the first moment, and a child node 712 of the node 710 may record the account ALICE has a balance of 1000 yuan. Suppose at the second moment, 500 yuan is transferred from the account ALICE to the account BOB, then at this point balances of both the account ALICE and the account BOB change. The node 720 may record various account information at the second moment. For example, leaf nodes 728 and 730 may record that at the second moment balances of the account ALICE and the account BOB are 500 yuan and 500 yuan respectively. A leaf node 724 may record the transfer operation from the account ALICE to the account BOB. Data at other intermediate nodes may be determined according to the Merkle principle.

The lower portion of FIG. 7 illustrates a physical view for storing a blockchain based database. In this physical view, data at various nodes are stored in a “keyword-value” fashion. For example, a record 740 stores information about the block 1, wherein a “keyword” field stores a hash value of the block 1, and a “value” field stores data of the block 1. Data at other nodes in the logical view may also be stored similarly, which is ignored here. It will be understood that FIG. 7 merely illustrates a schematic blockchain where account information at the first moment and the second moment is stored. In other implementations, the blockchain based database may further comprise account information at more moments, or may further comprise more complicated operations such as deposit, withdrawal, transfer and so on.

As seen from the above described principles, physical storage will comprise the dataset in the physical view as shown in FIG. 7 whatever the logical view of the blockchain based database is. Therefore, the method described in the subject matter may be applied with respect to the blockchain physical storage. In one example implementation of the subject matter described herein, the dataset 182 in the above described untrusted execution environment 180 may be blockchain physical storage. Specifically, first various records comprised in the blockchain physical storage may be obtained, and then the keyword index 212 may be constructed on the basis of corresponding keywords in the various records and may be used to manage the blockchain database with a higher security level during the operation of the blockchain database. In this implementation, the blockchain physical storage may be deployed in the above described untrusted execution environment 180, and the application 172 (e.g. a bank account management application) for accessing the blockchain database may be deployed in the TEE 170.

In this way, on the one hand, the blockchain based database may benefit from the security safeguard of the blockchain technology, and on the other hand, the blockchain based database may further benefit from additional safeguard of monitoring in the TEE 170 whether an anomaly occurs in the blockchain physical storage as provided by the subject matter described herein. It will be understood although cases where malware might add a record to or delete a record from the dataset 182 in the TEE 180 have been described above, in the blockchain based database, since records in the blockchain based physical storage are appended and immutable, only the case of detecting whether a record is added to the dataset is involved.

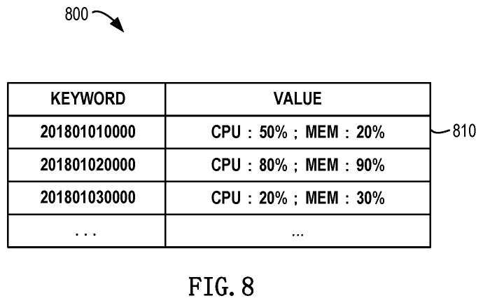

In one example implementation of the subject matter described herein, the dataset 182 in the above described untrusted execution environment 180 may further be a data table in a relational database. FIG. 8 schematically shows a block diagram 800 for managing a relational database according to one implementation of the subject matter described herein. Specifically, FIG. 8 illustrates a schematic view of a data table for recording logs of the operating system, wherein a keyword field may store timestamp data and a value field may store a detected state of the operating system. For example, a record 810 may represent a state of the operating system at 00:00 on Jan. 1, 2018: CPU usage is 50%, and memory usage is 20%. In this implementation, since log records are appended and immutable, only the case of detecting whether a record is added to the dataset is involved. In one example implementation of the subject matter described herein, when the dataset 182 is a data table in other form (e.g. the above described bank account database), an anomaly that malware has added a new record to or deleted existing data from the dataset 182 may further be detected.

In this way, on the one hand, the database as shown in FIG. 8 may benefit from the security safeguard of the encryption-decryption based technology of the database itself, and on the other hand, the database may further benefit from additional safeguard of monitoring whether an anomaly occurs in the database in the TEE 170 as provided by the subject matter described herein.

### Example Implementations

Some example implementations of the subject matter described herein are listed as below.

In one aspect, there is provided a computer-implemented method. The method comprises: obtaining a dataset comprising at least one record of which a record at least comprises: a keyword for identifying the record; and a value corresponding to the keyword; creating a keyword index in a trusted execution environment on the basis of respective keywords of the at least one record, the keyword index describing a set of keywords of the at least one record.

In some implementations, the method further comprises: in response to receiving a request for adding a new record to the dataset, updating the keyword index on the basis of a keyword of the new record; and adding the new record to the dataset.

In some implementations, the method further comprises: in response to receiving a request for reading a record in the dataset, determining a target keyword associated with the request; in response to a target record, which comprises the target keyword, not being found in the dataset, comparing the target keyword with the keyword index; and in response to the target keyword matching the keyword index, providing an indication indicating that an anomaly occurs in the dataset.

In some implementations, the method further comprises: in response to the target keyword mismatching the keyword index, providing an indication indicating that the dataset does not comprise a record associated with the request.

In some implementations, the method further comprises: in response to receiving a request for reading a record in the dataset, determining a target keyword associated with the request; in response to a target record, which comprises the target keyword, being found in the dataset, comparing the target keyword with the keyword index; and in response to the target keyword matching the keyword index, providing an indication indicating that the dataset comprises a target record associated with the request.

In some implementations, the method further comprises: in response to the target keyword mismatching the keyword index, providing an indication indicating that an anomaly occurs in the dataset.

In some implementations, the dataset is a dataset of a blockchain based database, and a record of at least one record in the dataset describes a keyword and a value of a node in the blockchain.

In some implementations, the dataset is stored in an untrusted execution environment.

In some implementations, the method further comprises: in response to receiving an access request for accessing the dataset, adding a record associated with the access request to a cache in the trusted execution environment.

In some implementations, the method is executed in the trusted execution environment.

In another aspect, there is provided a computer-implemented apparatus. The apparatus comprises: a processing unit; and a memory, coupled to the processing unit and including instructions stored thereon, the instructions, when executed by the processing unit, causing the apparatus to perform acts. The acts comprises: obtaining a dataset comprising at least one record of which a record at least comprises: a keyword for identifying the record; and a value corresponding to the keyword; creating a keyword index in a trusted execution environment on the basis of respective keywords of the at least one record, the keyword index describing a set of keywords of the at least one record.

In some implementations, the acts further comprise: in response to receiving a request for adding a new record to the dataset, updating the keyword index on the basis of a keyword of the new record; and adding the new record to the dataset.

In some implementations, the acts further comprise: in response to receiving a request for reading a record in the dataset, determining a target keyword associated with the request; in response to a target record, which comprises the target keyword, not being found in the dataset, comparing the target keyword with the keyword index; and in response to the target keyword matching the keyword index, providing an indication indicating that an anomaly occurs in the dataset.

In some implementations, the acts further comprise: in response to the target keyword mismatching the keyword index, providing an indication indicating that the dataset does not comprise a record associated with the request.

In some implementations, the acts further comprise: in response to receiving a request for reading a record in the dataset, determining a target keyword associated with the request; in response to a target record, which comprises the target keyword, being found in the dataset, comparing the target keyword with the keyword index; and in response to the target keyword matching the keyword index, providing an indication indicating that the dataset comprises a target record associated with the request.

In some implementations, the acts further comprise: in response to the target keyword mismatching the keyword index, providing an indication indicating that an anomaly occurs in the dataset.

In some implementations, the dataset is a dataset of a blockchain based database, and a record of at least one record in the dataset describes a keyword and a value of a node in the blockchain.

In some implementations, the dataset is stored in an untrusted execution environment.

In some implementations, the acts further comprise: in response to receiving an access request for accessing the dataset, adding a record associated with the access request to a cache in the trusted execution environment.

In some implementations, the method is executed in the trusted execution environment.

In a further aspect, there is provided a non-transient computer storage medium, comprising machine executable instructions which, when executed by a device, cause the device to execute a method in any of the above aspects.

In a still further aspect, there is provided a computer program product, tangibly stored on a non-transient computer storage medium and comprising machine executable instructions which, when executed by a device, cause the device to execute a method in any of the above aspects.

The functionally described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out methods of the subject matter described herein may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the subject matter described herein, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Conversely, various features that are described in the context of a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. A computer-implemented method, comprising:
obtaining a dataset comprising at least one record of which a record at least comprises:
a keyword for identifying the record; and
a value corresponding to the keyword;
creating a keyword index in a trusted execution environment on the basis of respective keywords of the at least one record, the keyword index describing a set of keywords of the at least one record.

2. The method of claim 1, further comprising:
in response to receiving a request for adding a new record to the dataset, updating the keyword index on the basis of a keyword of the new record; and
adding the new record to the dataset.

3. The method of claim 1, further comprising:
in response to receiving a request for reading a record in the dataset, determining a target keyword associated with the request;
in response to a target record, which comprises the target keyword, not being found in the dataset, comparing the target keyword with the keyword index; and
in response to the target keyword matching the keyword index, providing an indication indicating that an anomaly occurs in the dataset.

4. The method of claim 3, further comprising:
in response to the target keyword mismatching the keyword index, providing an indication indicating that the dataset does not comprise a record associated with the request.

5. The method of claim 1, further comprising:
in response to receiving a request for reading a record in the dataset, determining a target keyword associated with the request;
in response to a target record, which comprises the target keyword, being found in the dataset, comparing the target keyword with the keyword index; and
in response to the target keyword matching the keyword index, providing an indication indicating that the dataset comprises a target record associated with the request.

6. The method of claim 5, further comprising:
in response to the target keyword mismatching the keyword index, providing an indication indicating that an anomaly occurs in the dataset.

7. The method of claim 1, wherein the dataset is a dataset of a blockchain based database, and a record of at least one record in the dataset describes a keyword and a value of a node in the blockchain.

8. The method of claim 1, wherein the dataset is stored in an untrusted execution environment.

9. The method of claim 1, further comprising:
in response to receiving an access request for accessing the dataset, adding a record associated with the access request to a cache in the trusted execution environment.

10. The method of claim 1, wherein the method is executed in the trusted execution environment.

11. An apparatus, comprising:
a processing unit;
a memory coupled to the processing unit and comprising instructions stored thereon, the instructions, when executed by the processing unit, causing the apparatus to perform acts as below:
obtaining a dataset comprising at least one record of which a record at least comprises:
a keyword for identifying the record; and
a value corresponding to the keyword;
creating a keyword index in a trusted execution environment on the basis of respective keywords of the at least one record, the keyword index describing a set of keywords of the at least one record.

12. The apparatus of claim 11, wherein the acts further comprise:
in response to receiving a request for adding a new record to the dataset, updating the keyword index on the basis of a keyword of the new record; and
adding the new record to the dataset.

13. The apparatus of claim 11, wherein the acts further comprise:
in response to receiving a request for reading a record in the dataset, determining a target keyword associated with the request;
in response to a target record, which comprises the target keyword, not being found in the dataset, comparing the target keyword with the keyword index; and
in response to the target keyword matching the keyword index, providing an indication indicating that an anomaly occurs in the dataset.

14. The apparatus of claim 13, wherein the acts further comprise:
in response to the target keyword mismatching the keyword index, providing an indication indicating that the dataset does not comprise a record associated with the request.

15. A computer readable storage medium, on which a computer program is stored, the program, when executed by the processor, implementing a method according to claim 1.
